(19) United States
(12) Patent Application Publication
(10) Pub. No.: US 2026/0098588 A1
(43) Pub. Date: Apr. 9, 2026

(54) Check Valve With Override

(71) Applicant: Unibloc Hygienic Technologies UK, Ltd., Bolney (GB)

(72) Inventors: Robert George Grantham-Hill, Southwater (GB); Sebastian Antoni Soyke, Bolney (GB)

(73) Assignee: Unibloc Hygienic Technologies UK, Ltd., Bolney (GB)

(21) Appl. No.: 19/350,645

(22) Filed: Oct. 6, 2025

Related U.S. Application Data
(60) Provisional application No. 63/705,081, filed on Oct. 9, 2024.

(51) Int. Cl. F16K 15/18; F16K 15/06

(52) U.S. Cl. CPC F16K 15/182; F16K 15/06

(57) ABSTRACT

A check valve is provided with an over-ride configuration whereby a poppet located above a valve seat seals against the valve seat in a check valve configuration under the influence of at least one of gravity and fluid pressure from above the valve seat. A flow configuration occurs when pressure above the valve seat is lower than below the valve seat thereby at least assisting in pulling the poppet off the valve seat and permitting flow. An over-ride configuration exists due to foot downwardly extending from poppet through valve seat to below a lower section of the valve housing to contact a surface to thereby push the foot upwardly (and the poppet off the valve seat) so that flow could proceed in a direction normally prevented by the check valve configuration.

### CLAIM OF PRIORITY

This application claims the benefit of U.S. Provisional Application No. 63/705,081 filed Oct. 9, 2024, which is incorporated herein by reference in its entirety.

### FIELD OF THE INVENTION

The present invention relates to a check valve having a first configuration preventing flow in a first direction, and a second override configuration permitting flow both the first direction and a second direction opposite the first direction, and more specifically, to a non-return valve (NRV) having Clean-In-Place (CIP) capability.

### BACKGROUND OF THE INVENTION

Systems like applicant's U.S. Pat. No. 11,840,443, incorporated herein by reference, and others use lances to remove product from containers for various industries.

Some lances have non-return valves (NRV's) that permit flow of product/fluid in a single direction acting as a check valve. For systems like the '443 patent, flow with such an NRV could only proceed in a direction upwardly through the lances with the NRV preventing flow in the opposite direction, such as past the valve into the drums. When not in use, any fluid remaining in the lance cannot exit the lance through the NRV.

However, if flow can only occur in a single direction, there is no way to backflush or otherwise employ a clean in place (CIP) system to permit fluid to flow in the opposite direction for at least cleaning purposes.

A need exists for an improved Non-Return Valve (NRV) which employs at least a clean in place (CIP) feature, whereby an operator may direct the NRV to a position whereby not only may fluid flow through the NRV as designed, but also in an opposite direction to at least assist in cleaning/rinsing of the NRV and flange.

### SUMMARY OF THE INVENTION

It is an object of many embodiments of the present invention to provide a non-return valve (NRV) having a closed configuration preventing the flow of fluid through the valve possibly relying on gravity and fluid pressure to close the valve and an open configuration whereby fluid may not only flow in a first direction through the valve in normal operation, but also in a second direction, opposite the first direction, to permit at least rinsing/cleaning of the valve and/or lance.

It is an object of many embodiments of the present invention to provide an improved NRV having CIP capability.

It is an object of many embodiments of the present invention to provide an improved check valve normally permitting flow in a specific direction, but having an over-ride configuration permitting flow in both directions through the valve.

Accordingly, a valve has a first configuration as a check valve or a non-return valve. In this configuration, a valve poppet rests on a seat forming a seal possibly with the assistance of gravity and/or fluid above the valve poppet assisting in retaining the valve poppet on the seat. Fluid cannot flow past the poppet downwardly in this configuration.

For some embodiments, the suction force of a pump acting above the poppet, such as through fluid or otherwise, may be sufficient to pull the poppet upwardly off of the seat to permit suction of product in a first direction. When sufficient suction force is secured, the poppet returns to the seated and sealed configuration preventing fluid from flowing in a second direction, opposite the first direction, in such an embodiment.

For some other embodiments, the suction force of a pump may not be sufficient to pull the poppet off of the seat, or it may be desirable to over-ride the check valve feature in this or other situations. A foot connects to the valve poppet and extends from a bottom of the valve whereby the foot may contact a surface, such as the bottom of a container and then upwardly direct the poppet off the seat (whether there is suction or not above the poppet) in an over-ride configuration.

The over-ride configuration may not only be employed when removing contents from a container and contacting a bottom of the container, but also when a lance with the valve attached reaches the bottom of a clean-in-place (CIP) scabbard. The poppet may raise from the seat and allow cleaning products or byproducts of the cleaning process to flow around the valve upwardly or downwardly. Additionally, cleaning and rinse fluids may drain back through the lance tip out the normal inlet of the valve.

The housing of the valve preferably connects an outlet of the valve to a lance (normally having a substantially cylindrical shape). The lance may have threads, such as male threads which connect to female threads of the housing. An internal stop may limit movement of the poppet internal to the housing in an upward direction and the seat may limit movement of the poppet in the downward direction. Below the seat are preferably radially directed apertures permitting inflow of fluid (and outflow when in the over-ride configuration). A center portion of the bottom may have a bore through which the foot moves therethrough when transitioning from the stop flow position of the check valve and the fully open position of the over-ride configuration. The foot and bore combination may also act as a guide to retain the poppet in a desired position relative to the valve seat so that the valve seals shut in the stop flow position.

### BRIEF DESCRIPTION OF THE DRAWINGS

The particular features and advantages of the invention as well as other objects will become apparent from the following description taken in connection with the accompanying drawings in which:

FIG. 1 is a bottom perspective view of a valve of a presently preferred embodiment connected to a lance;

FIG. 2 is a cross section taken along the line A-A of FIG. 1 in a non-return configuration;

FIG. 3 is a cross section taken along the line B-B of FIG. 1 in an override configuration; and

FIG. 4 is a schematic view showing the valve and lance of FIGS. 1-3 connected to a pump with the lance in a one of a container and a clean in place (CIP) scabbard.

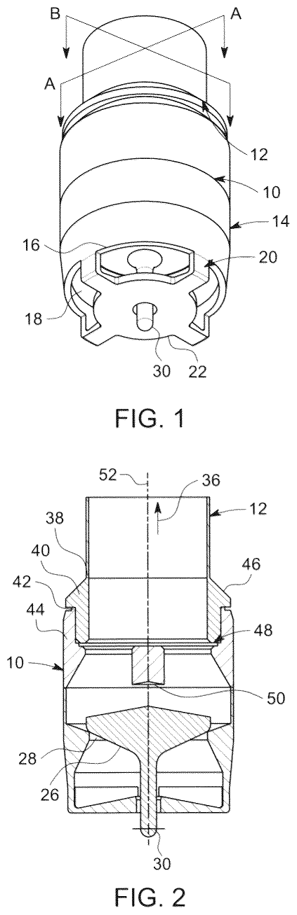

### DETAILED DESCRIPTION OF THE PREFERRED EMBODIMENTS

The figures show a valve 10 of a presently preferred embodiment of the present invention connected to a lance 12.

The valve has a lower section 14 having a plurality, such as four, radially directed inlet apertures 16,18,20,22 which normally receive a fluid product from various food or industrial environments from containers and direct that fluid up through the valve 10 and the lance 12 often through a pump 24 for further processing.

In order for fluid not to leak from the valve 10 or lance 12 when no suction, or insufficient suction, is being applied, the valve 10 has a check valve configuration with a stop flow position in which a poppet 26 rests against a valve seat 28 possibly with fluid from within the lance 12 and/or gravity having the poppet 26 seal against the valve seat 28 as shown in FIG. 2. This is the stop flow position of the check valve configuration. Poppet 26 is located to seal from above onto valve seat 28, below.

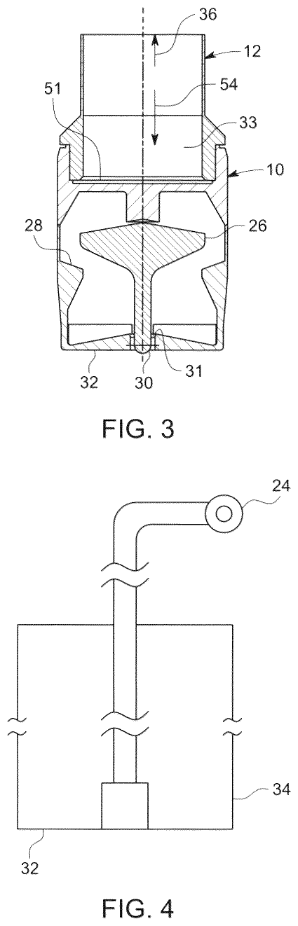

FIG. 3 shows an over-ride configuration whereby a foot 30 connected to the poppet 26 extends below a bottom surface of the lower section 14 and pushes the poppet 26 off of the valve seat 28 such as when the foot 30 contacts a surface 32 which could be a portion of a clean in place (CIP) scabbard drum, etc., illustrated as container 34 which could also be another container of fluid product, etc.

Referring back to FIG. 2 which is the check valve configuration. Flow can proceed in first direction 36, if at all. Some pumps 24 may be able to apply sufficient suction to pull poppet 26 off of seat 28 to pull fluid through inlet apertures 16,18,20,22 pass the valve seat 28 and poppet 26 and into lance 12 and on through pump 24 in a flow configuration. Other pumps 25 may not provide sufficient suction. In order to pull fluid in direction 36, the foot 30 contacts surface 32 and displaces poppet 26 relative to valve seat 28 as shown in FIG. 3. This is the over-ride configuration permitting flow potentially in either/both directions 36,54. Flow configuration exists when fluid is pumped from at least one inlet aperture 16,18,20,22, through valve seat 28 past poppet 26 through outlet.

The lance 12 may have a male fitting 38 having outwardly directed threads 40 which cooperate with inwardly directed threads 42 of housing 44 to connect the lance 12 to the valve 10 for at least some embodiments. O-ring seals 46,48 may be used with some embodiments.

An internal stop 50 within the housing 44 may limit travel of poppet 26 when off the seat 28 and be connected to the housing 44, and for many embodiments. Internal stop 50 may be supported by a beam 51 so as not to substantially interfere with flow out the outlet 33, or otherwise supported. The internal stop 50 may be aligned along an axis 52 of the valve. The poppet 26 and valve seat 28 also may preferably be aligned with the axis 52 for many embodiments. Poppet 26 and valve seat 28 preferably have cooperating surfaces to form a seal when in the seal position of the check valve configuration. The poppet 26 is preferably connected to the foot 30 such as by being an integral portion of the same component or connect thereto as would be understood by those of ordinary skill in the art.

When in the check valve configuration FIG. 2 shows the stop flow position where there is no reverse flow opposite to direction 36. Lance 12 is preferably vertically oriented. Gravity may assist on poppet 26 to seat 28 sealing as shown in FIG. 2.

When in the over-ride configuration of FIG. 3, flow can also proceed in second direction 54 which is opposite to first direction 36. Foot 30 is in contact with surface 32 of container 34 after passing through bore 31 of lower section 14 which could be a container of fluid, a scabbard of a clean in place (CIP) system, etc., as appropriate. If there is no suction or insufficient suction, pulling fluid in first direction 36 when in this configuration, then fluid, cleaning products or byproducts may exit out of the inlet apertures 16,18,20,22. If there is sufficient suction in direction 36, then fluid may proceed into inlet apertures 16,18,20,22, past valve seat 28 and poppet 26 and through lance 12 towards pump 24.

This design provides a valve 10 which can operate as a non-return valve (NRV) that is capable of being cleaned in place with a clean-in-place (CIP) system. Not only can the valve 10 stand alone for various uses, the valve 10 can be combined with manual or automatic suction lances 12, particularly when paired with drum (also, a container 34) unloading equipment such as shown in FIG. 4 as would be understood with reference to U.S. Pat. No. 11,840,443 and others. The lower section 14 preferably has a solid planar bottom having a single bore 31 therethrough to prevent sucking a portion of a bag or other item through the valve 10 at least in some embodiments and applications. At least one opening such as inlet apertures 16,18,20,22 may be radially outwardly directed as inlets in the lower section 14 below the valve seat 28. Foot 30 may extend downwardly from the poppet 26 through the bore 31 until contacting surface 32 at which time it may push foot 30 and poppet 26 upwardly until either poppet 26 contacts internal stop 50 and/or foot is flush with planar bottom 33 of lower section 14.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. A check valve with over-ride comprising:
a housing containing an outlet and a poppet above a valve seat;
said housing having a lower section below the valve seat with at least one inlet opening; and
a foot extending from the poppet through the lower section to below a lower portion of the lower section;
wherein at least one of gravity and fluid above the poppet assist in sealing the poppet to the valve seat in a check valve configuration when pressure at the outlet is greater than pressure at the at least one inlet opening in the check valve configuration;
a flow configuration where pressure at the outlet is less than pressure at the at least one inlet opening thereby at least assisting in pulling the poppet upwardly off of the valve seat for fluid flow to proceed from the at least one inlet opening through the valve seat and out the outlet; and
an over-ride configuration where the foot contacts a surface below the lower portion of the housing thereby pushing the poppet upwardly off the valve seat permitting fluid to pass from a direction of the outlet through the at least one inlet opening when pressure at the at least one inlet opening is less than pressure at the outlet.

2. The check valve with over-ride of claim 1 wherein the housing has threads which cooperate with threads of a lance and the housing is connected to a lance.

3. The check valve with over-ride of claim 2 wherein the lance is a portion of a drum unloading station.

4. The check valve with over-ride of claim 1 wherein the lower section has a solid planar bottom surface with a single bore opening with the foot proceeding through the bore in the check valve configuration.

5. The check valve with over-ride of claim 4 wherein the lower section has a plurality of inlet openings above the planar bottom surface.

6. The check valve with over-ride of claim 1 having an internal stop within the housing limiting upward travel of the poppet to a maximum distance from the valve seat in at least one of the over-ride configuration and the flow configuration.

7. The check valve with over-ride of claim 6 wherein the internal stop limits upward travel of the poppet to the maximum distance from the valve seat in both the over-ride and flow configurations.

8. The check valve with over-ride of claim 7 wherein the internal stop is axially aligned with the poppet and valve seat within the housing.

9. The check valve with over-ride of claim 6 wherein the internal stop is axially aligned with the poppet and valve seat within the housing.
